(19) United States
(12) Patent Application Publication
(10) Pub. No.: US 2006/0239646 A1
(43) Pub. Date: Oct. 26, 2006

(54) Device and method of storing an searching broadcast contents

(75) Inventor: Sung Suk Kang, Incheon (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/359,141

(22) Filed: Feb. 21, 2006

(30) Foreign Application Priority Data
Feb. 22, 2005 (KR) 10-2005-0014399

(51) Int. Cl. H04N 7/00

(52) U.S. Cl. 386/95

(57) ABSTRACT

A device and a method of storing and searching broadcast contents are provided. A video storing and searching system extracts a representation image and feature information of the representation image from video contents to be stored and stores the extracted representation image and the feature information together with the video contents. The stored video contents are searched using the feature information based on a query image provided from a user, and then a search result is displayed.

Pursuant to 35 U.S.C. § 119(a), this application claims the benefit of earlier filing date and right of priority to Korean Patent Application No. 10-2005-0014399, filed on Feb. 22, 2005, the content of which is hereby incorporated by reference herein in its entirety.

### BACKGROUND OF THE INVENTION 1. Field of the Invention

The present invention relates to a device and a method of storing and searching broadcast contents.

2. Description of the Related Art

There is provided a device for storing and playing back digital contents with a storage unit internally or externally such as a hard disc drive (HDD), a digital versatile disc (DVD), and a semiconductor memory.

An example of a device for storing and playing back digital contents with a storage unit can be a digital TV broadcast receiver. The digital TV broadcast receiver receives and outputs an analog TV broadcast signal and also a digital TV broadcast signal transmitted based on the ground wave or the satellite. Moreover, the received TV broadcast signal is stored in the storage unit and the stored TV broadcast signal can be played back and outputted in the digital TV broadcast receiver.

The digital TV receiver with the storage unit can store the digital TV broadcast signal or the analog TV broadcast signal, i.e., audio/video (A/V) signals using the storage unit in a form of a compressed digital signal stream, or playing back signals by decoding the A/V signals stored in the storage unit. These functions are called a private video recorder (PVR) function.

FIG. 1 is a flowchart illustrating a method of recording and searching a broadcast signal in a digital TV broadcast receiver.

In operation S10, a recording instruction for a currently watching or reserved broadcast program is inputted. Once the recording instruction is inputted, a broadcast signal corresponding to the program is received, and an broadcast information, i.e. program & system information protocol (PSIP)/electric program guide (EPG) information, is extracted from the received broadcast signal in operations S11 and S12. Next, it is determined that it is the analog broadcast or the digital broadcast in operation S13. In operations S14 and S15, a representation image is extracted from digital broadcast stream data in the case of the digital broadcast, and a representation image is extracted after encoding the analog broadcast signal in the case of the analog broadcast. Next, the additional information and the representation image are store in a storage unit together with broadcast data, i.e. A/V data in operation S16.

Then, whether playing back the recorded contents or not is determined in operation S17. When there is a playing back request, the list of previously recorded contents is provided to a user in operation S18. At this point, together with the A/V data, the stored representation image is provided in a thumbnail form, the program information such as a title of a program, a recording date and a playing back time is provided. The user searches and selects the recorded contents to be played back using the list of the recorded contents and the additional information. Next, the selected contents in the storage unit is decoded and played back in operations S18 and S19.

The user looks at the list of the recorded contents stored in the storage unit, checks each program information one by one, and searches the content to be played back. When, a plurality of video contents are stored in a high-capacity storage unit, it is difficult to find the recorded contents to be played back and also it takes a lot of time for searching. Therefore, it is very inconvenient for a user.

### SUMMARY OF THE INVENTION

Accordingly, the present invention is directed to a device and a method of storing and searching broadcast contests that substantially obviate one or more problems due to limitations and disadvantages of the related art.

An object of the present invention is to provide video contents storing and searching system capable of easily searching video contents.

Another object of the present invention is to provide video contents storing and searching system capable of recording a TV broadcast program and easily searching the recorded program in a TV broadcast receiver with a storage unit.

A further another object of the present invention is to provide a video contents storing and searching system capable of recording a digital TV broadcast program and easily searching the recorded program in a digital TV broadcast receiver with a storage unit.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a video storing and searching system extracting a representation image and feature information of the representation image from video contents to be stored and storing the extracted representation image and the feature information together with the video contents. The stored video contents are searched using the feature information based on a query image provided from a user, and then a search result is displayed.

In a video storing and searching system, a representation image can be one or more with respect to corresponding video contents and provided in a thumbnail.

In a video storing and searching system, a representation image can be one or more with respect to corresponding video contents, each representation image represents a specific interval in the corresponding video contents when more than two representation images are used.

In a video storing and searching system, the feature information to be used in a video contents search can use one or more than two among color information, object shape information, text information, music information, style information, and program information.

In a video storing and searching system, the video content is a broadcast program received in a digital TV receiver, the digital TV receiver includes a storage unit, and then a representation image of the corresponding program and feature information of the image are extracted and stored in the storage unit when recording the received broadcast program. The stored broadcast program is searched based on image feature information given by a query, and all or a portion of the corresponding program represented as a selected image within the search result is played back.

In a video storing and searching system, it is possible to search the video contents using image information in the digital TV broadcast receiver, to provide an image-based search function with respect to a recorded contents list, and to provide a recorded contents search faster than using only a recorded contents list.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart illustrating a method of recording and searching a broadcast signal in a digital TV broadcast receiver;

FIG. 2 is a block diagram of a digital TV receiver according to an embodiment of the present invention;

FIG. 3 is a block diagram illustrating a structure of a broadcast recording unit according to an embodiment of the present invention;

FIG. 4 is a block diagram illustrating a structure of a broadcast playing back unit according to an embodiment of the present invention;

FIG. 5 is a view of an example of a color-based search result according to an embodiment of the present invention; and

FIG. 6 is a view of an example of a color/shape-based search result according to an embodiment of the present invention.

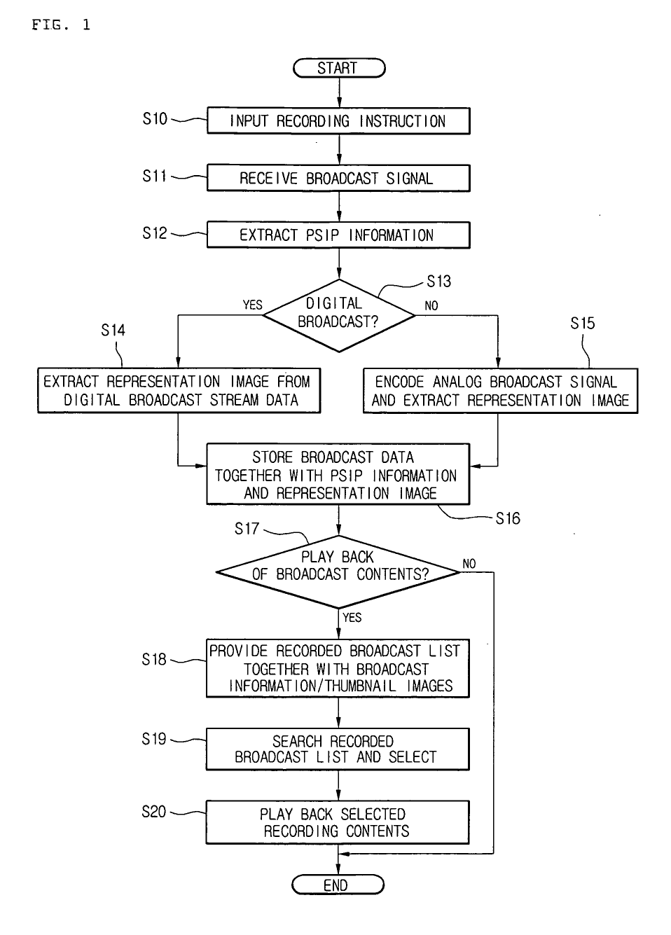

### DETAILED DESCRIPTION OF THE INVENTION

An embodiment of a device for searching and storing video contents will be described. There is provided a digital TV receiver recording a digital TV broadcast program as video contents, and searching and playing back the recorded program. The digital TV receiver includes a set-top box. The digital TV receiver receives and encodes an analog TV broadcast signal and also a digital TV broadcast signal transmitted based on the ground wave or the satellite. Moreover, the received TV broadcast signal is stored in the storage unit and the stored TV broadcast signal can be played back and outputted in the digital TV broadcast receiver. The digital TV receiver includes a storage unit internally or externally. Here, the storage unit can be various kinds of storage medium such as a HDD, an optical recording device, and a semiconductor memory device.

Additionally, the digital TV receiver, which is described with reference to the accompanying drawings, is not limited to a broadcasting type. Here, a mentioned broadcasting type of the present invention is just one example and the present invention is not limited to the mentioned broadcasting type.

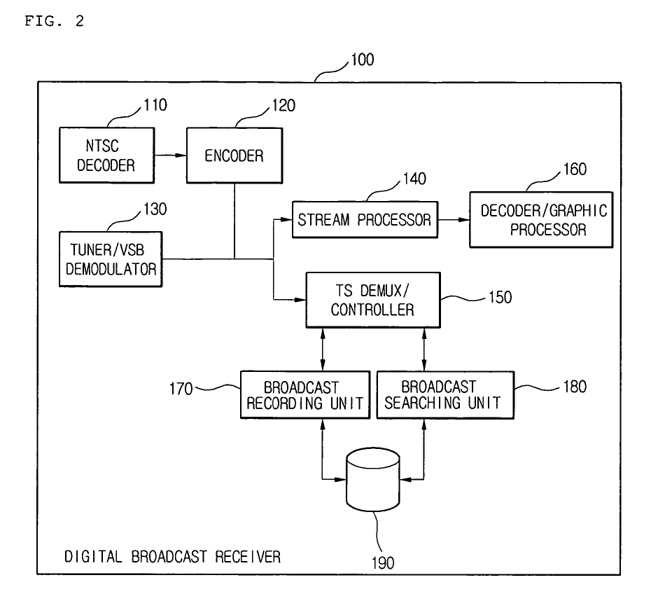

FIG. 2 is a block diagram of a digital TV receiver according to an embodiment of the present invention.

As illustrated in FIG. 2, a digital TV receiver 100 includes an National Television System Committee (NTSC) decoder 110, an encoder 120, a tuner/vestigial side band (VSB) demodulator 130, a stream processor 140, a transport stream demux/controller 150, a decoder/graphic processor 160, a storage unit 190, a broadcast recording unit 170, and a broadcast searching unit 180.

The NTSC decoder 110 converts a received analog TV broadcast signal into a digital signal, and transmits the converted signal into the encoder 120. The encoder 120 encodes the transmitted broadcast signal, i.e., a moving picture experts group (MPEG)-based encoding, and multiplexes the encoded broadcast data into a transport stream. The tuner/VSB demodulator 130 receives a selected digital TV broadcast signal, demodulates the received signal, and outputs the demodulated signal after the A/V data and PSIP information are separated.

The stream processor 140 processes the demodulated A/V data or an encoded A/V data stream, and then transmits the processed result to the decoder/graphic processor 160. The decoder/graphic processor 160 decodes an inputted A/V data and displays the decoded data on a display device. The TS demux/controller 150 interprets PSIP information of the received broadcast signal and controls storing and playing back of the broadcast signals.

The broadcast recording unit 170 extracts the PSIP information of the received broadcast signal, a representation image of the video contents to be stored, and feature information of the extracted representation image, and then stores corresponding video contents, additional information, a representation image, feature information in the storage unit 190.

The broadcast searching unit 180 searches the representation image of the stored video contents, the stored feature information, and the PSIP information, and then outputs the search result with the corresponding video contents, additional information, and the representation image.

A user interface is not shown in FIG. 2, but included for a user interface to control the TV receiver. The user interface, for example, can be a remote controller. The user can select channel to watch and input a recording instruction using the remote controller. Here, the recording includes a real time recording for the broadcast program of a currently watching channel and the reserved program.

According to a device operation using the user interface, a broadcast program of a specific channel is selected by the NTSC decoder 110 or the tuner/VSB demodulator 130. The broadcast signal of the selected channel is demodulated, decoded, and encoded, and then outputted to the outputting device through the stream processor 140 and the decoder/graphic processor 160.

The TS demux/controller 150 stores the A/V signal and the PSIP-based additional information in the storage unit 190 through the broadcast recording unit 170 when recording the broadcast program. Moreover, the broadcast searching unit 180 searches the broadcast program stored in the storage unit 190 i.e., the video contents (including audio) and then provides the search result to the user through a display device when playing back the stored broadcast program. To play back the user-selected contents from the search result, the TS demux/controller 150 performs the stream process and the decoding/graphic process on the selected contents and then outputs the processed contents.

In this way, the representation image is extracted from the corresponding video contents when the A/V signal is stored. The representation image is extracted in a thumbnail image form. The representation image selects a representation frame, and then uses as the thumbnail image. There are various methods to extract the representation image from the video contents. The representation image can be an image that is created corresponding to the relevant contents, a first frame of the relevant contents, and more than two images created selecting frames at a predetermined time interval. The representation image is connected to the corresponding contents or a specific interval of the contents by assigning an index.

The feature information is extracted from the representation image of the video contents. Here, the feature information can be expressed with a feature vector. The feature vector can use one or more than two among color information, shape information, text information, music information, style information, additionally provided and extractable program information. The broadcast recording unit 170 stores the extracted representation image and the feature information in the storage unit together with the corresponding video contents.

Additionally, the additional information for the broadcast program to be recoded is obtained through the PSIP interpretation and the extraction. The additional information can be, for example, a broadcasting station name, date/time, and playing time of the corresponding contents. The extracted information is created corresponding to the one video contents, and stored together in the storage unit 190 as the information of the corresponding video contents.

The stored recorded contents is searched in a following method, and the video contents selected by the user is played back from the search result. According to the present invention, the video contents is searched by querying an image. Let's examine when the thumbnail image is used as the representation image.

First, when querying the thumbnail image that the user searches, the feature vector of the queried thumbnail image is obtained, and then compared to feature vector of the each thumbnail images stored on a database of the storage unit. The search result is outputted after comparing the similarity between the feature vector of the queried image and the feature vector of the stored thumbnail image. For example, when the similarity between them is over the predetermined value, the thumbnail images are outputted as the search result. In the search result, the thumbnail images are displayed representing the corresponding video contents.

The feature vector used in searching and recording the video contents can use a descriptor proposed by a MPEG7. For example, when using the MPEG7 dominant color descriptor, the feature vector for the most distributed color in the corresponding thumbnail is extracted, and also can be used to search the thumbnail images containing the specific color. For another example, when using a MPEG7 color layout descriptor, the feature vector for a shape and/or color of the specific object is extracted from the corresponding thumbnail, and can be used to search images determined to be similar because of having the specific shape and/or color.

In a method of displaying the search result, the thumbnail images can be displayed together with additional information about corresponding video contents that each thumbnail image represents. In addition to the searching method of querying the thumbnail image, the user examines a list of the recording contents, searches the corresponding video contents by querying a broadcasting station name, a program name, data, etc., and then can perform the above feature vector-based search by querying the thumbnail image from a list of the searched recording contents in another searching method.

When the user selects one video contents to be played from the search result, the corresponding video contents is played back from the beginning, the point where the corresponding thumbnail image is extracted, or the specific interval where the corresponding thumbnail image represents.

FIG. 3 is a block diagram illustrating a structure of a broadcast recording unit 170 according to an embodiment of the present invention. The case that thumbnail image is used as the representation image will be described.

As illustrated in FIG. 3, the broadcast recording unit 170 includes a thumbnail extracting module 172, a thumbnail vector extracting module 174, a PSIP information extracting module 176, and a recording module 178.

The thumbnail extracting module 172 extracts a representation image, i.e. a thumbnail image, from the broadcast signal transmitted through the TS demux/controller 150. That is, the thumbnail extracting module 172 extracts a video frame representing the corresponding broadcast program (video contents) at a predetermined interval. Here, the representation frame is image data provided as the thumbnail image on the searching display.

The thumbnail vector extracting module 174 creates feature information about the representation images, i.e. descriptor, together with an index representing the corresponding representation frame.

According to the MPEG7, multimedia data expressing technique and a method of defining a relationship between each data is standardized by defining data, feature, descriptor, description scheme, description, coded description, etc. The MPEG7 satisfies requirement specifications such as searching, location, and filtering, etc., and also can be applicable to the various fields related to Pull (search/location) and Push (filtering) techniques.

When based on the MPEG7, the descriptor describes the broadcast contents related features such as color information of an object, shape information of the object, text information, music information (the period of a playing segment), style information (a subjective feature such as an expressed emotion, etc. are described in the display), and information of program (an author, a maker, a director, etc.).

The PSIP information extracting module 176 extracts a information for searching from the PSIP information. The PSIP information includes identifying information of a broadcasting station and a channel, a reception tuning method, whether broadcasting a multi-program or not, and a method of searching information on the multi-program. The PSIP information extracting module 176 additionally extracts broadcast information such as a broadcasting station name, a broadcast data, a playing time, etc. from the PSIP information, which is used as a searching component of the broadcast contents.

The recording module 178 stores broadcast data, representation frames, feature information corresponding to the representation frames (descriptors), indexes and broadcast information (PSIP information) in the storage unit together with broadcast contents, i.e. video contents.

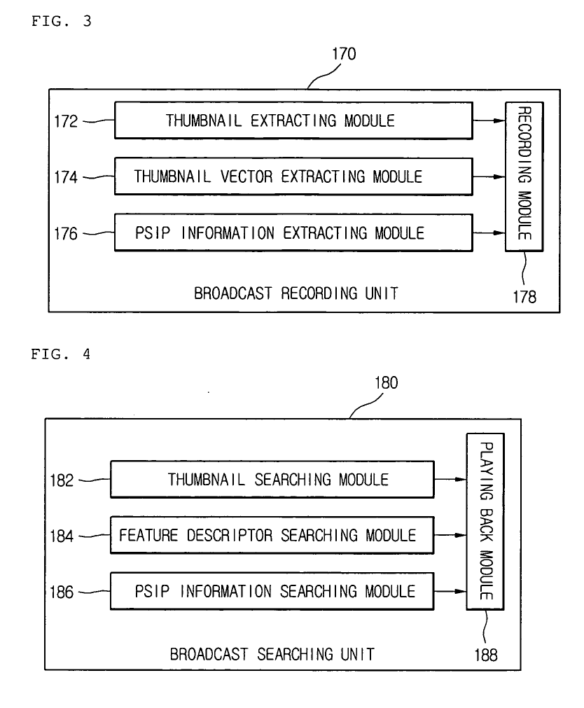

FIG. 4 is a block diagram illustrating a structure of a broadcast playing back unit according to an embodiment of the present invention. The broadcast searching unit 180 includes a thumbnail searching module 182, a feature descriptor searching module 184, a PSIP information searching module 186, and a playing back module 188.

The thumbnail searching module 182 provides the video frame to be a representation image as a thumbnail image on the display, and searches the broadcast contents to be played when a user performs a searching query using the image. At this point, a thumbnail image viewer is used. When the user selects one thumbnail image, the thumbnail searching module 182 searches the broadcast contents (video contents) corresponding to the selected thumbnail image, and then delivers the search result to the playing back module 188.

The PSIP information searching module 186 receives a broadcast information key word such as a broadcasting station name, a broadcast data, a broadcast channel, etc. from the user, and then searches the broadcast contents corresponding to the key word. The PSIP information searching module 186 categorizes information of the searched recording contents, displays the information, and delivers the selected result to the playing back module 188 when the user selects a broadcast program to watch.

The feature descriptor searching module 184 provides the representation frames as the thumbnail images using the thumbnail image viewer. The searching is started when the user selects a thumbnail image having a characteristic similar to that of the contents to be played.

The feature descriptor searching module 184 provides a feature descriptor keyword as a menu when one of the thumbnail image is selected. For example, when the user selects a “color” item, the feature descriptor searching module 184 searches another representation frame having a “color” feature descriptor similar to those of other representation frames corresponding to the selected thumbnail image in the database of the previously stored representation images (representative video frames).

That is, the feature descriptor searching module 184 compares the “color” feature descriptor of the selected representation frame to those of the other representation frames. Then, when the similarity between them is over a predetermined numerical value, the feature descriptor searching module 184 selects the corresponding “color” feature descriptors, and also searches the representation frames with reference to the index.

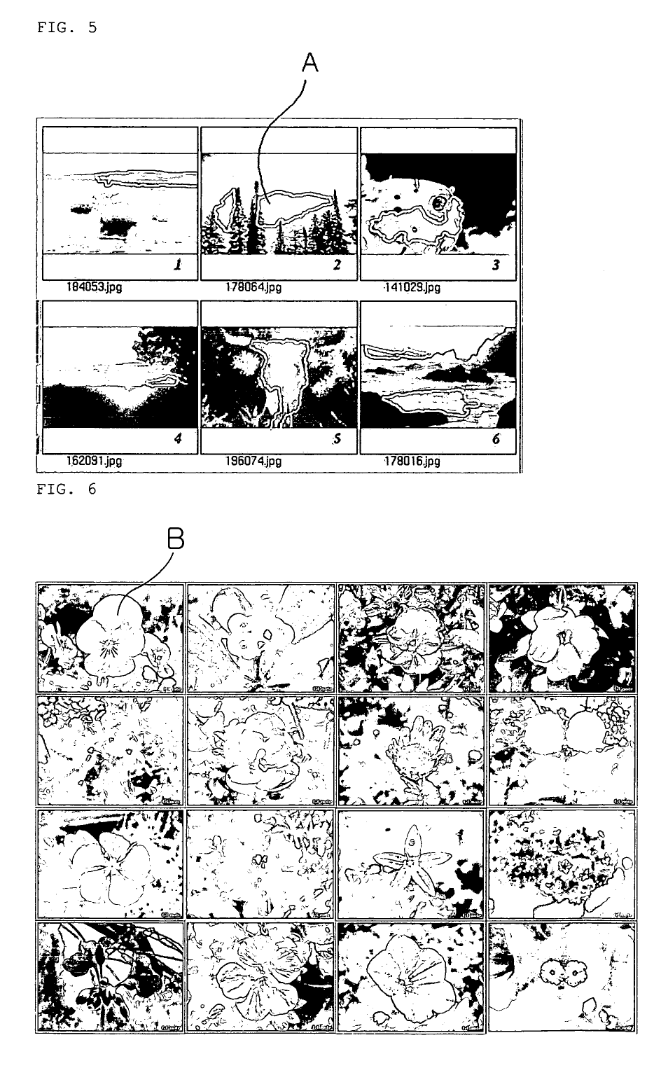

In FIG. 5, the broadcast searching unit 180 displays a search result of the similar thumbnail images using the “color” feature descriptor. The broadcast searching unit 180 displays a region A having commonly identical or extremely similar color in the thumbnail images of the searched representation frames.

For another example using the representation image feature information, the feature descriptor searching module 184 can search the corresponding representation frame by comparing “color/shape” feature descriptors. In this case, the feature descriptor searching module 184 searches representation frames having an object with similar color and shape and then displays the result.

In FIG. 5, the broadcast searching unit 180 displays a search result of the similar thumbnail images using the “color/shape” feature descriptor. The search result is displayed, which includes flower-shaped objects B with commonly similar color in the thumbnail images of the searched representation frames.

As described above, when a plurality of the searched and representation frames are displayed using the feature descriptor, a representation frame is selected, which corresponds to a user-wanted broadcast contents. Then, the feature descriptor searching module 184 delivers the selected result to the playing back module 188.

When the representation frame or broadcast information is finally searched and selected by the thumbnail searching module 182, the feature descriptor searching module 184, and the PSIP information searching module 186, the playing back module 188 accesses the corresponding broadcast contents from the storage unit 190, and delivers the broadcast contests to the TS demux/controller 150. Then, the delivered contents is played back and outputted through the stream controller 140 and the decoder/graphic processor 160.

At this point, the playing back module 188 provides a selecting menu about a playing back method or a playing back interval, receives a choice of whether the selected broadcast contents to be played back from the beginning or not, from the position corresponding to the representation frame used in the searching or not, or within only a specific interval. Then, the playing back module 188 plays back an entire broadcast contents or a portion of the broadcast contents according to the choice result.

According to the present invention of the a video storing and searching system, under the situation with a contents storing device of a large capacity and a great increase of the number of broadcast contents in the TV receiver, it is efficient of searching the user-wanted broadcast contents because of using the feature information addition to the basically text-based broadcast information.

Moreover, according to the present invention, it is unnecessary to remember a broadcast program title, a representative screen, etc. that user wants to watch, and search the broadcast recording list one by one. That is, the broadcast contents can be conveniently searched using diversely somewhat inaccurate information by applying partial information of color, an object shape, a text, a music segment, style, and program information, etc displayed frequently in the broadcast program.

Additionally, according to the present invention, since it is unnecessary to manage the broadcast contents stored in a large volume one by one, and it is convenient to search the broadcast contests each time the user wants to play back, the user can record a large volume of broadcast contests without a burden.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of storing and searching broadcast contents, comprising:
extracting a representation image of video contents and feature information of the representation image;
storing the corresponding video contents together with the extracted representation image and the feature information;
searching the stored video contents using the feature information;
displaying the search result represented in corresponding representation images; and
playing back video contents corresponding to a selected representation image in the displayed search result.

2. The method according to claim 1, wherein the image is stored and represented as a thumbnail image.

3. The method according to claim 1, wherein additional information about the video contents is extracted and stored, and the search result with the stored additional information is displayed.

4. The method according to claim 1, wherein the feature information is described in a corresponding image.

5. The method according to claim 1, wherein the feature information comprises one or more than two among color information, object shape information, text information, music information, style information, and program information.

6. A method of recording broadcast contents, comprising:
creating a representation image by extracting a video frame from audio/video contents of a received TV broadcast;
extracting feature information of the representation image; and
storing the created representation image and the extracted feature information together with corresponding audio/video contents.

7. The method according to claim 6, wherein the representation image is a thumbnail image.

8. The method according to claim 6, wherein the representation image includes one image representing audio/video contents with respect to one audio/video contents or images representing each playing back interval with respect to one audio/video contents.

9. The method according to claim 6, wherein the feature information is described in a corresponding image.

10. The method according to claim 6, wherein the feature information comprises one or more than two among color information, object shape information, text information, music information, style information, and program information.

11. The method according to claim 6, wherein an index of the representation image is created and stored together with the feature information.

12. A method of searching broadcast contents, comprising:
selecting a query image to search audio/video contents of stored TV broadcast;
searching audio/video contents corresponding to a query based on image feature information of the selected query image with respect to the stored audio/video contents;
displaying representation images of the searched audio/video contents; and
playing back audio/video contents corresponding to a selected image among the displayed representation images.

13. The method according to claim 12, wherein the image is represented as a thumbnail image.

14. The method according to claim 12, wherein the feature information is described in a corresponding image.

15. The method according to claim 12, wherein the feature information comprises one or more than two among color information, object shape information, text information, music information, style information, and program information.

16. The method according to claim 12, wherein audio/video contents corresponding to an image selected among the displayed representation images is played back from the beginning or a starting position of an interval representing a corresponding image.

17. The method according to claim 12, wherein the search result of audio/video contents is outputted according to similarity between feature information of the selected query image and feature information of a representation image of the stored audio/video contents.

18. The method according to claim 12, wherein the image feature information to be searched in a query image is selected according to a search keyword about the query image.

19. A TV receiver comprising:
a recording unit extracting a video frame from video contents of a TV broadcast signal to create a representation image, and extracting feature information of the created representation image to store;
a storage unit storing the extracted representation image and the feature information together with the corresponding video contents; and
a searching unit searching the stored video contents using a query image and feature information of a representation image.

20. The TV receiver according to claim 19, wherein the representation image is a thumbnail image.

21. The TV receiver according to claim 19, wherein the representation image includes one image representing video contents with respect to one video contents or images representing each playing back interval with respect to one video contents.

22. The TV receiver according to claim 19, wherein the feature information is described in a corresponding image.

23. The TV receiver according to claim 19, wherein the feature information comprises one or more than two among color information, object shape information, text information, music information, style information, and program information.

24. The TV receiver according to claim 19, wherein an index of the representation image is created and stored together with the feature information.

25. The TV receiver according to claim 19, wherein audio/video contents corresponding to an image selected among the displayed representation images is played back from the beginning or a starting position of an interval representing a corresponding image.

26. The TV receiver according to claim 19, wherein the search result of audio/video contents is outputted according to similarity between feature information of the selected query image and feature information of a representation image of the stored audio/video contents.

27. The TV receiver according to claim 19, wherein the image feature information to be searched in a query image is selected according to a search keyword about the query image.
